(19) United States
(12) Patent Application Publication
(10) Pub. No.: US 2009/0277039 A1
(43) Pub. Date: Nov. 12, 2009

(54) Pheumatic dewatering of particulate

(76) Inventor: Robert Rooksby, Carmel, IN (US)

Correspondence Address: Thomas A. Ladd, 5802 N. Dearborn St., Indianapolis, IN, 46220, US

(21) Appl. No.: 12/387,799

(22) Filed: May 7, 2009

Related U.S. Application Data
(60) Provisional application No. 61/126,955, filed on May 8, 2008.

(51) Int. Cl. F26B 3/10; F26B 17/10

(52) U.S. Cl. 34/367; 34/371; 34/591; 34/580

(57) ABSTRACT

Disclosed and claimed is a pneumatic dryer for removal of liquid from the surface of particulate. The dryer finds application in drying water from coal using air as a drying gas. A significant mechanism of the removal of liquid from particulate is the shearing of liquid without a phase change from the particulate surface.

This application claims benefit from provisional patent application 61/126,955, filed May 8, 2008.

The present invention relates to the dewatering of particulate materials by air streams. Primarily, the invention relates to dewatering of coal in a particulate size, but the disclosed and claimed invention may be applied to removal of water from the surface of a particulate generally. The basis of the system is that fluidized coal particles introduced in a non-axial orientation into a gas stream and transported through a cylindrical tube or conduit physically separate small (aerosol) water droplets from the coal particle surface. Fluidized coal and associated water aerosols enter a gravity separation chamber where the coal particles are released and the water aerosol droplets and fine coal particulates are entrapped in either a neutral or a negative pressure duct and report to a wet scrubber for collection.

Optionally, the gas stream is set up on a closed circuit whereby, once the water aerosol droplets are entrapped in the wet scrubber, the ambient air exiting the wet scrubber may be re-cycled through to the inlet of the pneumatic gas stream fan for recirculation. In so doing, the return air being pulled through the system may increase in temperature to the point that it enhances further the moisture removal by evaporation, in addition to the high velocity shearing of aerosol-water droplets.

Also, optionally, the moisture-laden return air may be de-humidified, preferably by refrigerated coils.

Surface moisture may collect on coal from several sources, as is the case for uncovered coal storage piles exposed to precipitation. Water may be used in some mining operations to separate finely divided coal from larger sizes. These coal fines are often flushed to ponds where they are entrapped and, in time, become an environmental and safety hazard.

Industrial sized coal fired steam generation often makes use of coal as a particulate which is then associated with combustion air and blown into the combustion chamber. A portion of the heat generated by the combustion of coal is required to convert the associated surface moisture on the coal to steam at the temperature in the combustion chamber. Additionally, at start-up of coal-fired combustion outside sources of supplemental heat may be utilized, such as natural gas or oil, injected into the chamber to heat the coal combustion environment to a temperature sufficient for continuous combustion of particulate coal. The energy required to convert the surface moisture of the fine coal particulate to steam at the temperature of the combustion chamber is lost. By removing the surface moisture from coal particulate prior to introduction of particulate coal into the combustion chamber, energy efficiency may be realized in a number of forms including, but not limited to, a decrease in station service energy requirement, increase in gross power generation, reduction in coal mill operating requirements while maintaining a full load, improvement in heat rate and higher Btu feedstock at the same cost to the power plant as they are presently paying for lower Btu feedstock.

A further environmental benefit from coal free of surface moisture results from the ignition of dry, fine coal at a lower temperature than fine, water-laden coal. Because ignition at a lower temperature may be effected, the generation of nitrogen oxides, NOₓ, during combustion is reduced when compared with NOₓ generated by combustion of water-laden, fine coal.

Coal mining operations may separate higher value large particle sized coal from fine particles. For practical purposes fine coal may be considered as particles having a maximum dimension of ¼ in (6 mm) or less. The separated fine particles eventually become exposed to water from precipitation, or storage in water ponds which prevents the fine coal from becoming airborne particulate. Surface water laden fine coal has a reduced heating value as opposed to surface water laden larger particles of the same coal because increased surface to volume ratio of the fine particles results in a larger quantity of water for a given mass of coal. Thus, fine coal is more difficult to market for the coal mine, and becomes a disposal problem at the mine. By removal of aerosol water droplets according to the disclosure and claims, surface water laden fine coal can be increased in heating value.

Surface moisture laden fine coal may also complicate operation of coal fired furnace operations such as coal-fired, steam-powered, electric generator stations. Large coal stockpiles exposed to precipitation accumulate surface moisture. Because of its friable nature, when coal is handled parts of the particles break off thus exposing more surface area to precipitation. The heating value of coal is thereby reduced by handling and by precipitation. Removal of surface moisture from fine coal according to the disclosure and subsequent claims can provide energy efficiency and cost savings to coal-fired combustion such as used by coal-fired, steam-powered, electric generator stations.

While finding significant application in the removal of surface moisture from coal, the invention disclosed and claimed finds utility in the removal of surface moisture from particulates such as blast furnace sludge, minerals such as lime, and polymeric materials produced in a solution including water, such as emulsion polymerized elastomers.

Pneumatic transport of particulate material disclosed in the art includes U.S. Pat. No. 4,145,453 related to size reduction and transport of cheese in particulate form.

EP Patent application 0 099 653 A1 concerns a pneumatic conveyor, including the use of heated, dried air fed at a radial location, while particulate is augured generally co-axially with the pipe of the pneumatic conveyor. It is taught that offset pneumatic pipes generated a spiral air-flow in the pneumatic conveyor.

U.S. Pat. No. 6,170,768 concerns pneumatic conveyance wherein airlocks separate the pressurized pneumatic conveyor and particulate collection system from the atmosphere.

Particulate is contributed to the pneumatic conveyor generally co-axially with the pipe of the pneumatic conveyor.

The disclosure of the identified references is incorporated herein by reference.

In undertaking to apply the known art to drying by removal of aerosol water droplets from particulate, especially coal particulate, applicants found that co-axial contribution of particulate to the pipe of the pneumatic conveyor and the addition of air for conveyance of the particulate in an annulus surrounding the particulate addition resulted in unstable operation including: variation in the flow rate of particulate conveyed by a constant air flow; plugging of the pneumatic conveyor with particulate and air blowback through the particulate feed.

Applicant endeavored to address the problems experienced and to simplify the apparatus for the drying of particulate, especially coal, while enhancing results in total moisture reduction and increasing production flow rates, thereby maximizing efficiency.

### BRIEF DESCRIPTION OF THE DRAWINGS

FIG. 1 is a view representing a pneumatic particulate dryer.

FIG. 2 is a side view of an alternative embodiment of a pneumatic particulate dryer.

FIG. 3 is a top view of the stilling chamber and scrubber portion of the alternative embodiment of FIG. 2.

FIG. 4 shows an end section of an individual stilling chamber.

FIG. 5 is a section of a mixing chamber 300 with attached connections.

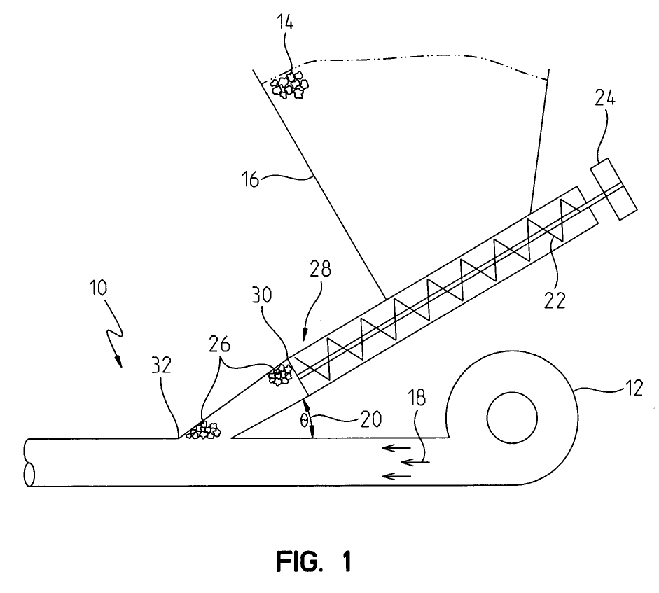

In operation of the pneumatic dryer according to FIG. 1, air is injected axially into the pneumatic conveyor 10 in the form of a pipe having most simply a circular cross section from a positive displacement blower 12. Particulate 14 is extruded by a screw auger 22 driven by motor 24 from a hopper 16 into the flowing air stream 18 in a non-axial position, thereby aspirating the particulate into the gas stream at an angle 0 20. The particulate forms a plug 26 in the extruder 28 substantially blocking back flow of pressurized air. The plug is advanced toward the pipe of the pneumatic conveyor by a screw conveyor that stops short of the pipe of the pneumatic conveyor. The angle θ at which the extruded plug of particulate material intersects the pneumatic conveyor advantageously ranges from about 25 to 45 degrees. For coal angles from 30 to 40 degrees are found useful.

Efforts to effect pneumatic coal drying apparatus of the prior art that introduce coal particulate axially into the conduit for combination with air supplied from a generally radial (non-axial) orientation, or axially directed air provided through a nozzle arrangement to align transport air axially with particulate resulted in unacceptable downstream clogging of the conduit (tube) or unacceptable low particulate flow rates were necessary to maintain flow in the conduit.

It has been found that the disclosed apparatus operates in a stable manner. Moreover, the apparatus is significantly simplified over the prior art, particularly in the combination of particulate to the gas stream in other than an axial orientation.

Not wishing to be bound by any particular theory of operation, it is understood that moisture is removed by gas passing the particulate at a high relative rate of speed. The relative speed difference between the particulate and the gas is highest where the particulate is aspirated into the flowing gas stream. While evaporation may play a role in the moisture removal, particularly where warm or heated air is used, since moisture removal is observed even where water saturated gas (air) is used, shear of liquid water from the surface of the particles is believed to play the predominant role in moisture removal from the particulate.

As a simplified pneumatic dryer, the present invention is very mobile and therefore suited for transportation to coal mine pond sites or to the location of coal-fired steam generators, or other coal fired applications.

Heated air may be utilized for drying. At a coal fired steam generator location, otherwise wasted heat may be utilized to enhance the moisture capacity of the air.

If desired, the particulate may be classified by collecting the dried particulate in separated bins as illustrated by FIG. 20 of U.S. Pat. No. 6,170,768.

### EXAMPLE 1

Coal from a pond at a coal mine in the state of Alabama was tested for moisture content by ASTM D3302-07. 26.88% moisture was found.

The coal was subsequently subjected to pneumatic drying as disclosed herein and transported in a metal pipe with an inside diameter of 4 inches, into a stilling chamber having a length of 32 feet at a particulate flow rate of 1,000 lbs/hour and an ambient air flow rate of 975 ft³/min. The dried material was found to have 4.17% moisture content.

The Btu output of the coal increased from 10,450 prior to drying to 13,268 following drying as measured by ASTM D5142-04

### EXAMPLES 2-7

Coal as identified in Table 1 was pneumatically dried with ambient air temperature as disclosed with the results of moisture reduction and Btu increase disclosed.

### EXAMPLE 8

Lime particles were pneumatically dried with ambient air as disclosed with the results of moisture reduction disclosed.

TABLE 1

| | | Initial | Dried | Initial | Dried |
|---|---|---|---|---|---|
| | | Moisture | Moisture | Btu | Btu |
| Example | Identifier | Percent | Percent | Output | Output |
| 1 | Alabama Pond | 26.88 | 4.17 | 10,450 | 13,268 |
| | Fines | | | | |
| 2 | Met Coal Filter | 16.75 | 5.88 | 11,658 | 13,045 |
| | Cake | | | | |
| 3 | Met Coal Pond | 31.00 | 8.24 | 11,111 | 12,561 |
| | Fines | | | | |
| 4. | Illinois Pond | 26.23 | 19.94 | 7,113 | 8,598 |
| | Fines | | | | |
| 5. | Kentucky Pond | 22.16 | 12.65 | 10,092 | 11,169 |
| | Fines | | | | |
| 6. | Colorado Filter | 10.53 | 5.34 | 11,893 | 12,641 |
| | Cake | | | | |
| 7. | Alabama Filter | 12.73 | 4.55 | 12,186 | 13,213 |
| | Cake | | | | |
| 8. | S. Carolina Lime | 14.43 | 6.59 | n/a | n/a |

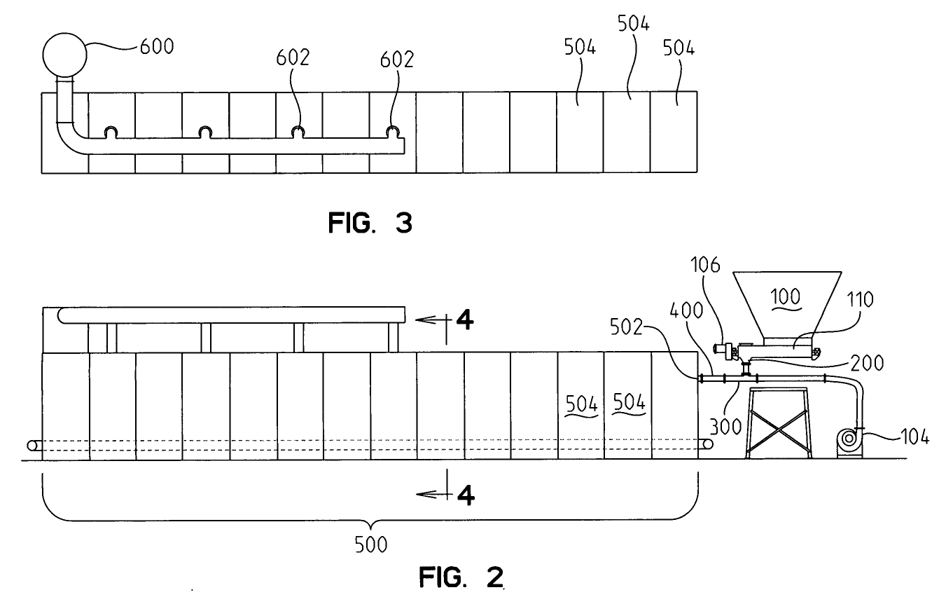

FIG. 2 illustrates a side view of an alternative embodiment of a claimed pneumatic particulate dryer comprising a feed bin 100, a connector 200, a mixing chamber 300, a transportation conduit 400, a stilling chamber 500, and a wet-dust collector 600. The feed bin 100 and associated components hereafter described conveys particulate 102, for example, wet, fine coal to the connector 200 for subsequent mixing with high-speed air in the mixing chamber. To provide particulate to the connector, one or more conveyors 110 of the helix, or ribbon type are driven to rotate by one or more motors 106.

In operation, if the feed bin 100 is placed above the mixing chamber 300, gravity will assist in providing a stream of particulate through the connector 200 into the mixing chamber configured A conveyor 110 is shown as a screw or ribbon conveyor. A conveyor is useful to control feed rate of particulate into the connector 200. Alternate configurations may eliminate the conveyor.

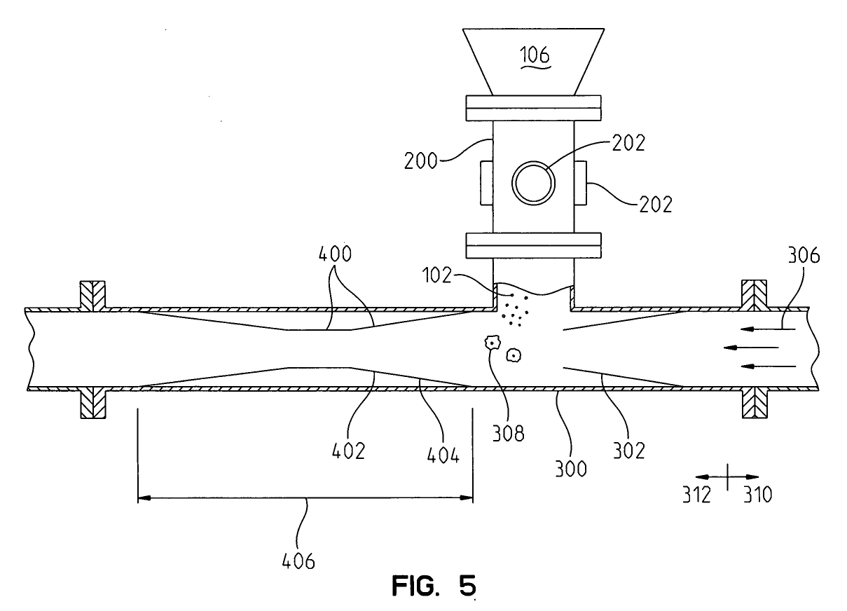

FIG. 5 provides a cross-section view of an embodiment of a mixing chamber 300 with associated connections: to a source of pressurized gas through a first venturi 302 of the mixing chamber; to connector 200 which provides a conduit for passage of particulate into the mixing chamber; to the transportation conduit 400. The first venturi 302 is expected to provide a vacuum in the vicinity of the mixing chamber resulting from the passage of compressed gas through the venturi. The compressed gas may be air compressed by a positive displacement blower 104. The vacuum provided is expected to draw the particulate 102 into the mixing chamber from the connector 200. Optional openings 202 in the connector admit air into the connector to aspirate the particulate to assist in the free-flow thereof into the mixing chamber. The size and number of openings 202 may be optimized by the operator.

The mixing chamber comprises the first venturi 302. The stream of compressed gas e.g., air from a positive displacement blower 104, enters the mixing chamber through the first venturi 302 in the flow direction indicated by the arrow 306. Initially, as the particulate 102 enters the mixing chamber, it has no movement in the flow direction. Although not wishing to be bound by a specific theory of operation, it is understood that as the gas passes the particulate at a rapid rate, the particulate becomes entrained in the gas eventually flowing in the transportation conduit 400 at a speed approaching the speed of the flowing gas. In the transition of the particulate from having no movement in the flow direction to flowing in the transportation conduit at a speed approaching the speed of the flowing gas in the conduit, the flowing gas is thought to remove surface moisture without a phase change from the liquid state from the surface of the particulate, by a shearing mechanism.

Freedom to move the first venturi 302 in the direction further in to the mixing chamber 312, or out of the mixing chamber 310 allows an operator to optimize particulate throughput according to the characteristics of the particulate such as particle size, density, adhesion of one particle to another etc., and the operational characteristics of the pneumatic dryer apparatus, such as the flow rate (speed) of pressurized gas, etc. Practically effective removal of surface moisture requires a gas speed of about 11,000 ft/min (3360 m/min) measured in the transport conduit 400. More effective moisture removal occurs at greater speeds up to 55,000 ft/min (16,800 m/min). Practically, the speed of the gas stream may be limited by the nature of the solid particulate. Due to the friable nature of coal, higher gas speeds results in increased particle size degradation to smaller particle size. The smaller particle size may be useful in the case of pneumatic dewatering at the location of a coal-fired station. Particle size degradation may reduce the value of coal at a mine location.

It is also understood that fluid may be removed from the particulate by a phase change from liquid to gas if the passing gas is not in a saturated state with respect to the fluid, e.g., water. Fluid removal by phase change from liquid to the gas phase may predominate in the conduit where the speed of the particulate approaches the speed of the gas in which it flows. The combined gas and particulate 308 proceed into the transportation conduit 400, passing first through a second venturi 402 resulting from a narrowing 404 of the conduit 400. In the second venturi 402, the gas is further accelerated in proportion to the diminished cross-section of the conduit 400. It is believed that the less dense gas accelerates past the particulate in the second venturi thereby generating a second shearing zone 406 within and immediately following the narrowing 404 of the transportation conduit.

In FIG. 2 is shown the stilling chamber 500. Upon entering the stilling chamber, the enlarged cross-section enables the pressurized gas to expand to fill a larger volume, permitting the particles entrapped in the gas to fall under the influence of gravity into various bins 504. The size, shape, and density of a particle impacts the distance the particle travels in the stilling chamber, as does the speed and density of the gas in which the particle is suspended. The term aerodynamic diameter is associated with the settling characteristics of particles. Aerodynamic diameter is an expression of a particle's aerodynamic behavior as if it were a perfect sphere having unit-density and diameter equal to the aerodynamic diameter.

In the case of coal particles, those particles that remain water laden, and therefore having a higher density will generally travel further from the entrance 502 of the stilling chamber before settling in to a bin 504.

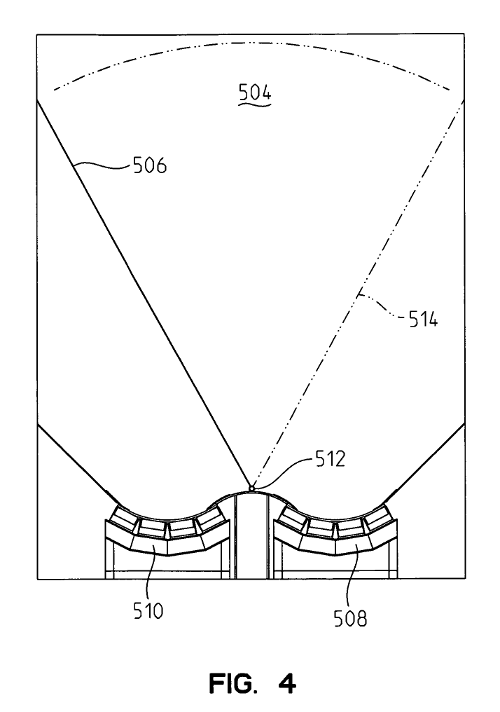

In FIGS. 2 and 4, a plurality of bins 504 is a useful optional feature of a stilling chamber to separate particulate according to density/aerodynamic diameter. Optionally, each bin may be equipped with a door 506 which may direct the particles reaching the particular bin to one or more conveyors 508, 510. Door 506 is shown hinged at location 512. As shown, door 506 directs particulate dropping into the bin to conveyor 508. Conveyors 508 and 510 may travel in opposite directions. Relocated to alternate door position 514, door 506 would direct particulate onto conveyor 510.

The option to remove particulate from more than one conveyor enables continuous operation of the pneumatic dryer and selection of particles according to their properties. For example, coal particles of a particular size or size range may be selected as boiler feed. Particle sizes not selected for boiler feed may be removed for size reduction followed by use as boiler feed, or if too small for boiler feed, for other use or disposal. An alternate criterion for coal may be the energy value of the coal which is related to the extent to which water is removed by the pneumatic dryer. If the cut-off of energy value of coal is, for example, 8000 Btu/ton, stilling chamber bins where coal settles having values of 8000 Btu/ton or greater may be conveyed for use. Bins containing coal having lower energy values may be blended with high heating value coal to the cut-off limit, or recycled for further drying.

Some operating conditions or particulate sources may generate particulate of an aerodynamic diameter such that particulate remains in the gas exiting the stilling chamber. In FIG. 3, a wet-dust collector 600 of the cyclone or wet scrubber type prevents escape of such particulate. A fan (not shown) draws the drying gas and any not-settled particulate from the stilling chamber at one or more gas exits 602 to the dust collector. If the stilling chamber has a plurality of exits, overall throughput of the dryer may benefit from adjusting the openings of one or more gas exits. Particulate on the order of 1 μm maximum dimension and smaller are anticipated to advance to the dust collector.

While the invention claimed is described by reference to specific details, such details are provided as illustrations, not limitations of the invention disclosed and claimed. Without departing from the spirit and scope of the invention claimed the skilled artisan may modify the invention claimed.

1. An apparatus for pneumatic drying of particulate comprising a pneumatic conveyor for flowing a pressurized gas axially therein, and non-axial addition of particulate to a flowing gas stream.

2. The apparatus of claim 1 having an angle of intersection of particulate and the pneumatic conveyor of from 25 to 45 degrees.

3. The apparatus of claim 1 wherein the particulate is coal.

4. The apparatus of claim 1 wherein the particulate passes through a conduit open to ambient air prior to combining with pressurized gas.

5. The apparatus of claim 4 wherein the particulate combines with pressurized gas that has exited from a first venturi.

6. The apparatus of claim 5 wherein particulate and pressurized gas pass through a second venturi before entering a transportation conduit.

7. The apparatus of claim 6 wherein the transportation conduit connects with a stilling chamber comprising one or more bins.

8. The apparatus of claim 7 wherein one or more bins may selectively direct particulate to more than one removal conveyor.

9. The apparatus of claim 2 wherein the angle of intersection is from 30 to 35 degrees.

10. A method of drying particulate material comprising
flowing a pressurized gas in a pipe;
combining in a non-axial orientation particulate into the pipe of flowing gas;
separating the moisture laden air from dried particulate and collecting the dried particulate.

11. The method of claim 10 wherein the particulate is coal.

12. The method of claim 10 wherein the particulate is selected from the group consisting of blast furnace sludge, minerals, and an emulsion polymer.

13. The method of claim 10 wherein the particulate is collected from selective bins in a stilling chamber.

14. The method of claim 10 wherein the flow rate of gas exceeds 10,000 ft/min.

15. The method of claim 14 wherein the flow rate of gas is from 11,000 to 55,000 ft/min.
